(19) United States
(12) Patent Application Publication
(10) Pub. No.: US 2016/0184967 A1
(43) Pub. Date: Jun. 30, 2016

(54) NOZZLE, CLEANING DEVICE, AND CLEANING METHOD

(71) Applicant: YOUTEC CO., LTD., Chiba (JP)

(72) Inventors: Tsutomu UJIIE, Chiba (JP); Yuuji HONDA, Chiba (JP)

(21) Appl. No.: 14/911,594

(22) PCT Filed: Aug. 13, 2013
(86) PCT No.: PCT/JP2013/071882

§ 371 Date: Feb. 11, 2016

(51) Int. Cl. B24C 5/04; B05B 7/14; B24C 1/00

(52) U.S. Cl. CPC B24C 5/04; B24C 1/003; B05B 7/1486

(57) ABSTRACT

To suppress the generation, on a surface to be cleaned of a substrate after cleaning, of metal contamination caused by erosion of an inner wall of a path of a nozzle. One aspect of the present invention is a nozzle 11 that causes CO₂ particles to be ejected to a substrate, wherein a hard film having a Vickers hardness of Hv 1000 to 5000 is formed on an inner wall of the nozzle.

### TECHNICAL FIELD

The present invention relates to a nozzle that causes CO₂ particles to be ejected, and a cleaning device and a cleaning method for performing cleaning by using CO₂ particles.

### BACKGROUND ART

FIG. 4 is a schematic view for explaining a conventional cleaning device.

This cleaning device includes: a cylinder (not illustrated) containing liquefied carbon dioxide (liquefied CO₂) pressurized to be 6 MPa; a nozzle 101 connected to the cylinder; a holding mechanism (not illustrated) that holds a substrate 102; a duct 104 having a suction port 104a; a blower; and a HEPA filter. The holding mechanism is a mechanism that holds the substrate 102 at a position where a front surface (a surface to be cleaned) of the substrate 102 is substantially parallel to the horizontal plane, and the surface of the substrate 102 faces upward (in a direction opposite to the direction of gravity).

The cleaning device operates in the following way. The pressurized liquefied CO₂ within the cylinder is supplied to the nozzle 101, CO₂ particles 103 of the liquefied CO₂ ejected through the nozzle 101 are sprayed onto the front surface of the substrate 102 held by the holding mechanism, and thus particles or the like attached onto the substrate 102 are blown off, with the result that the particles or the like blown off are sucked using a blower, from a suction port 104a on the side of the substrate 102, and are removed. In addition, the particles or the like passing through the duct 104 from the suction port 104a are captured by the HEPA filter, and a gas obtained by removal of the particles or the like is supplied onto the substrate 102 again. The nozzle 101 is made of stainless, and the substrate 102 is, for example, a silicon wafer or a glass substrate after lift-off in a semiconductor process. Note that the technique related to the above-described cleaning device is disclosed in Patent Literature 1.

Incidentally, in the case of the above-described conventional cleaning device, when the liquefied CO₂ passes through the nozzle 101, the CO₂ particles 103 collide with the inner wall of the path of the nozzle 101 made of stainless, and thus the small amount of metal such as Fe or Cr on the inner wall of the path is slightly eroded, which may result in ejection of the CO₂ particles 103 containing the metal. These CO₂ particles 103 clean a silicon wafer or a glass substrate, and thus metal such as Fe or Cr remains on the front surface of the silicon wafer or glass substrate after cleaning and the metal may contaminate the silicon wafer or the glass substrate.

Furthermore, in the case of the above-described conventional cleaning device, the substrate 102 is held by the holding mechanism a position where the front surface (surface to be cleaned) of the substrate 102 faces upward, and is substantially parallel to the horizontal plane. Therefore, after particles or the like on the substrate 102 are blown off by the CO₂ particles 103 sprayed onto the front surface of the substrate 102 from the nozzle 101, the particles or the like may be re-attached onto the front surface of the substrate 102. Accordingly, in some cases, the particles or the like are left on the front surface of the substrate 102 after the cleaning, thereby decreasing the cleaning effect of the front surface of the substrate. In particular, as the size of the substrate becomes larger, the particles or the like become more likely to be re-attached, which easily leads to the decrease in the cleaning effect.

In addition, in the case of the conventional cleaning device described above, particles or the like that have passed through the duct 104 from the suction port 104a are removed using the HEPA filter, a gas after removal of the particles or the like is supplied onto the substrate 102 again, and thus fine metal powders, burrs or the like the HEPA filter cannot capture may be sometimes re-attached onto the substrate 102. As a result, the cleaning effect of the front surface of the substrate may be sometimes lowered.

### PRIOR ART DOCUMENT

### Patent Document

Patent Literature 1: U.S. Pat. No. 6,099,396

### DISCLOSURE OF THE INVENTION

### Problems to be Solved

An aspect of the present invention has an object to suppress the generation, on the surface to be cleaned of a substrate after cleaning, of metal contamination caused by erosion of the inner wall of a path of a nozzle.

In addition, another aspect of the present invention has an object to suppress decrease in a cleaning effect due to re-attachment of particles or the like.

### Means for Solving the Problem

Hereinafter, various aspects of the present invention will be described.

[1] A nozzle that causes CO₂ particles to be ejected to a substrate, wherein

a hard film having a Vickers hardness of Hv 1000 to 5000 is formed on an inner wall of the nozzle.

[2] The nozzle according to [1] described above, wherein

the hard film is a film containing one selected from the group consisting of DLC, TiN, TiCrN, CrN, TiCNi, TiAlN, Al₂O₃, AlCrN, ZrO₂, SiC, Cr, NiP, WC, SiO₂, Ta₂O₅, SiN, and SiaAlbOcNd (sialon).

[3] The nozzle according to [1] or [2] described above, wherein

the hard film is a DLC film, and

the DLC film contains not more than 30 atomic % of hydrogen.

[4] The nozzle according to [3] described above, wherein

the DLC film is formed by a plasma CVD method using a high-frequency output with a frequency of 10 kHz to 1 MHz (preferably, 50 kHz to 800 kHz).

[5] The nozzle according to [3] described above,

the DLC film is formed by a plasma CVD method using a high-frequency output with a frequency of 50 kHz to 500 kHz.

[5-1] A manufacturing method of a nozzle that causes CO₂ particles to be ejected to a substrate, the method including the step of

forming a DLC film on an inner wall of the nozzle by a plasma CVD method using a high-frequency output with a frequency of 10 kHz to 1 MHz (preferably, 50 kHz to 800 kHz).

[6] The nozzle according to any one of [1] to [5] described above, wherein

the nozzle is a Venturi tube.

[7] A cleaning device, including:

the nozzle according to any one of [1] to [6] described above;

a CO₂ supplying mechanism that supplies pressurized CO₂ to the nozzle; and

a holding mechanism that holds a substrate, wherein

the pressurized CO₂ is supplied to the nozzle, and CO₂ particles ejected from the nozzle is used to clean the substrate held by the holding mechanism.

[8] The cleaning device according to [7] described above, including:

an exhaust mechanism disposed at a lower part of the substrate held by the holding mechanism, wherein

the holding mechanism holds the substrate at a position where an angle formed by a horizontal plane and a surface on a side opposite to a surface to be cleaned of the substrate is in a range of 45° to 180° (preferably 70° to 110°).

[9] The cleaning device according to [7] or [8] described above, wherein

an angle formed by a direction in which CO₂ particles are ejected from the nozzle and a surface to be cleaned of the substrate is in a range of 20° to 90°.

[10] The cleaning device according to [8] or [9] described above, wherein

the exhaust mechanism includes an exhaust port disposed at a lower part of the substrate, and an exhaust path connected to the exhaust port, and

the exhaust path has a path extending at a lower part of the exhaust port.

[11] The cleaning device according to any one of [8] to [10] described above, wherein

the substrate held by the holding mechanism and the nozzle are disposed within a chamber, and

a gas exhausted by the exhaust mechanism is discharged to the outside of the chamber.

[12] A cleaning device, including:

a holding mechanism that holds a substrate;

a nozzle that causes CO₂ particles to be ejected to the substrate held by the holding mechanism;

a CO₂ supplying mechanism that supplies pressurized CO₂ to the nozzle; and

an exhaust mechanism disposed at a lower part of the substrate held by the holding mechanism, wherein

the holding mechanism holds the substrate at a position where an angle formed by a horizontal plane and a surface on a side opposite to a surface to be cleaned of the substrate is in a range of 45° to 180° (preferably 70° to 110°).

[12-1] The cleaning device according to [12] described above, wherein

the nozzle is a Venturi tube.

[12-2] The cleaning device according to [12] or [12-1] described above, wherein

an angle formed by a direction in which CO₂ particles are ejected from the nozzle and a surface to be cleaned of the substrate is in a range of 20° to 90°.

[13] The cleaning device according to any one of [12], [12-1], and [12-2] described above, wherein

the exhaust mechanism includes an exhaust port disposed at a lower part of the substrate, and an exhaust path connected to the exhaust port, and

the exhaust path has a path extending at a lower part of the exhaust port.

[14] The cleaning device according to any one of [12], [12-1], [12-2], and [13] described above, wherein

the substrate held by the holding mechanism and the nozzle are disposed within a chamber, and

a gas exhausted by the exhaust mechanism is discharged to the outside of the chamber.

[15] A cleaning device, including:

a holding mechanism that holds a substrate;

a nozzle that causes CO₂ particles to be ejected to the substrate held by the holding mechanism;

a CO₂ supplying mechanism that supplies pressurized CO₂ to the nozzle; and

an exhaust mechanism disposed at a lower part of the substrate held by the holding mechanism, wherein

the exhaust mechanism includes an exhaust port disposed at a lower part of the substrate, and an exhaust path connected to the exhaust port, and

the exhaust path has a path extending at a lower part of the exhaust port.

[16] The cleaning device according to [15] described above, wherein

the substrate held by the holding mechanism and the nozzle are disposed within a chamber, and

a gas exhausted by the exhaust mechanism is discharged to the outside of the chamber.

[17] A cleaning method of a substrate by using CO₂ particles ejected from a nozzle, wherein

a hard film having a Vickers hardness of Hv 1000 to 5000 is formed on an inner wall of the nozzle.

[18] The cleaning method according to [17] described above, wherein

the hard film is a film containing one selected from the group consisting of DLC, TiN, TiCrN, CrN, TiCNi, TiAlN, Al₂O₃, AlCrN, ZrO₂, SiC, Cr, NiP, WC, SiO₂, Ta₂O₅, SiN, and SiaAlbOcNdq (sialon).

[19] The cleaning method according to [17] described above, wherein

the hard film is a DLC film, and

the DLC film contains not more than 30 atomic % of hydrogen.

[19-1] The cleaning method according to any one of [17] to [19] described above, wherein

the nozzle is a Venturi tube.

[20] The cleaning method according to any one of [17] to [19], and [19-1] described above, wherein,

when the substrate is cleaned, the substrate is disposed at a position where an angle formed by a horizontal plane and a surface on a side opposite to a surface to be cleaned of the substrate is in a range of 45° to 180° (preferably 70° to 110°).

[20-1] The cleaning method according to any one of [17] to [20], and [19-1] described above, wherein

an angle formed by a direction in which CO₂ particles are ejected from the nozzle and a surface to be cleaned of the substrate is in a range of 20° to 90°.

[21] A cleaning method of a substrate by using CO₂ particles ejected from a nozzle, wherein,

when the substrate is cleaned, the substrate is disposed at a position where an angle formed by a horizontal plane and a surface on the side opposite to a surface to be cleaned of the substrate is within a range of 45° to 180° (preferably 70° to 110°).

[22] The cleaning method according to any one of [20], [20-1], and [21] described above, wherein

exhaustion is performed from a lower part of the substrate when the substrate is cleaned.

[22-1] The cleaning method according to [21] or [22] described above, wherein

the nozzle is a Venturi tube.

[22-2] The cleaning method according to any one of [21], [22], and [22-1] described above, wherein

an angle formed by a direction in which CO₂ particles are ejected from the nozzle and a surface to be cleaned of the substrate is in a range of 20° to 90°.

### Effects of the Invention

According to one aspect of the present invention, it is possible to suppress the generation, on the surface to be cleaned of the substrate after cleaning, of metal contamination caused by erosion of the inner wall of the path of the nozzle.

Furthermore, according to another aspect of the present invention, it is possible to prevent decrease in cleaning effect due to re-attachment of particles or the like.

### BRIEF DESCRIPTION OF THE DRAWINGS

FIG. 1 is a diagram schematically illustrating a cleaning device according to an aspect of the present invention.

FIG. 2 is a diagram of a holding mechanism and an exhaust mechanism each illustrated in FIG. 1, when viewed from a front surface side of a substrate 12.

FIG. 3(A) is a sectional view illustrating a nozzle 11 illustrated in FIG. 1, and FIG. 3(B) is a diagram of the nozzle illustrated in FIG. 3(A) when viewed from the base end side of the nozzle.

FIG. 4 is a schematic view for explaining a conventional cleaning device.

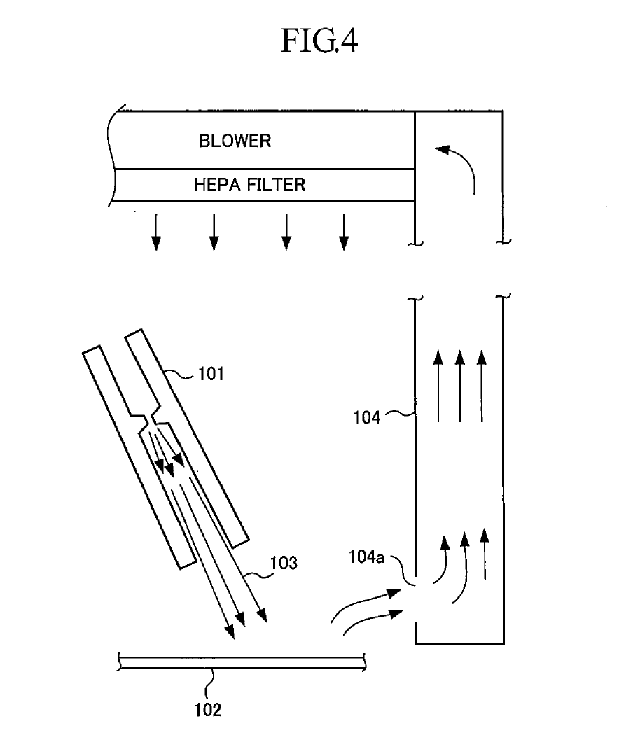

### BEST MODE FOR CARRYING OUT THE INVENTION

Hereinafter, embodiments of the present invention will be explained in detail using the drawings. However, a person skilled in the art would be able to easily understand that the present invention is not limited to the following explanation but the configuration and details thereof can be changed variously without deviating from the gist and the scope of the present invention. Accordingly, the present invention should not be construed as being limited to the description of the present embodiments shown below.

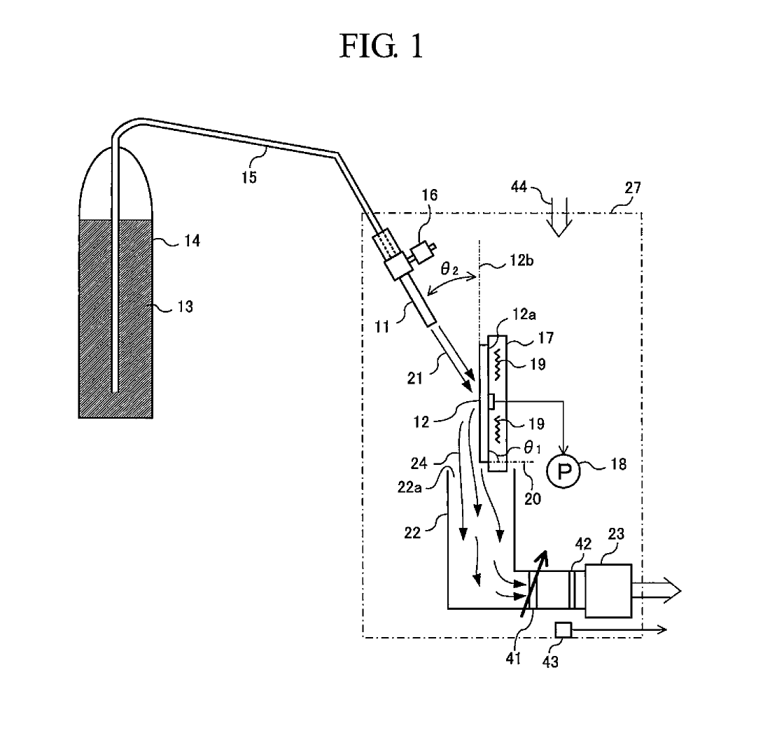

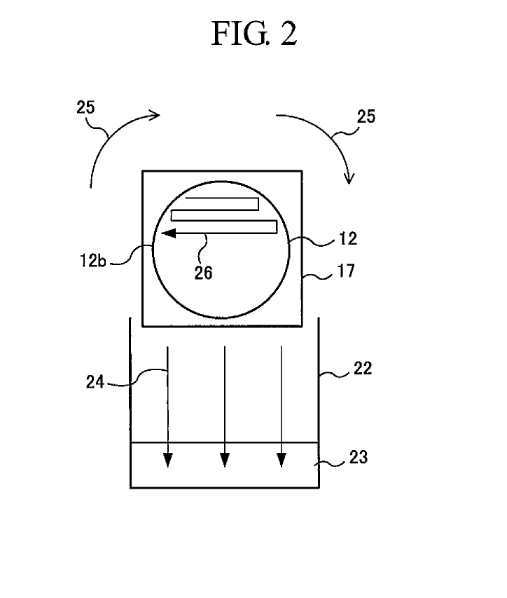

As illustrated in FIG. 1 and FIG. 2, the cleaning device includes a nozzle 11, a CO₂ supplying mechanism that supplies pressurized liquefied carbon dioxide (liquefied CO₂) to the nozzle 11, a holding mechanism that holds a substrate 12, and an exhaust mechanism disposed at a lower part of the substrate 12.

It is preferable that the nozzle 11 is a Venturi tube or a de Laval nozzle. Note that, in the present DESCRIPTION, the Venturi tube refers to a tube obtained by applying the Venturi effect. The Venturi effect is an effect that reduces flow of fluid to thereby increase the fluid velocity, and the de Laval nozzle is: a tube having a narrowed portion in the middle of its path through which fluid passes; a nozzle having an hourglass-like path; and a nozzle that accelerates the fluid after the fluid passes through this nozzle, thereby being able to give a supersonic speed. The Venturi tube includes the de Laval nozzle.

The CO₂ supplying mechanism has a cylinder 14 containing liquefied carbon dioxide (liquefied CO₂) 13 pressurized to 6 MPa, and this cylinder 14 is connected to one end of a valve 16 by a piping 15. It is preferable that the piping 15 has a siphon. The other end of the valve 16 is connected to one end of the nozzle 11. When the valve 16 opens, the pressurized liquefied CO₂ 13 within the cylinder 14 is supplied to the nozzle 11 through the piping 15 and the valve 16, and CO₂ particles are ejected from the other end of the nozzle 11.

The holding mechanism includes a holding portion 17 that holds the substrate 12, and a vacuum pump 18 connected to the holding portion 17. The substrate 12 is vacuum-sucked to the holding portion 17 and held, by evacuation with the vacuum pump 18. The angle θ₁ formed by the horizontal plane 20 and a surface (back surface) 12a on the side opposite to the surface to be cleaned of the substrate 12 held by the holding portion 17 is 90°. Furthermore, a heater 19 that heats the substrate 12 is disposed at the holding portion 17.

Note that, in the embodiment, the angle θ₁ formed by the horizontal plane 20 and the surface 12a on the side opposite to the surface to be cleaned of the substrate 12 is set to 90°. However, the angle is not limited to this, and any angle may be possible as long as the angle θ₁ is within a range of 45° to 180°.

It is preferable that an angle θ₂ formed by a direction 21 of CO₂ particles ejected from the nozzle 11 and the surface to be cleaned (front surface) 12b of the substrate 12 is within a range of 20° to 90°.

The exhaust mechanism includes an exhaust port 22a disposed at a lower part of the substrate 12, an exhaust path 22 connected to the exhaust port 22a, and an exhaust means (for example, an exhaust pump) 23 connected to the exhaust path 22. The exhaust path 22 has a path extending at a lower part of the exhaust port 22a. Note that, in the DESCRIPTION, the wording of “a lower part” indicates a direction of gravity.

Furthermore, the exhaust path 22 has a pressure control valve 41 disposed therein, and is configured such that the pressure control valve 41 can control exhaust pressure by using the exhaust means 23. Moreover, the exhaust path 22 has a HEPA filter 42 provided therein, and is configured such that the HEPA filter 42 captures particles or the like in the exhaust, and gas after removal of the particles or the like is discharged to the outside of a chamber 27.

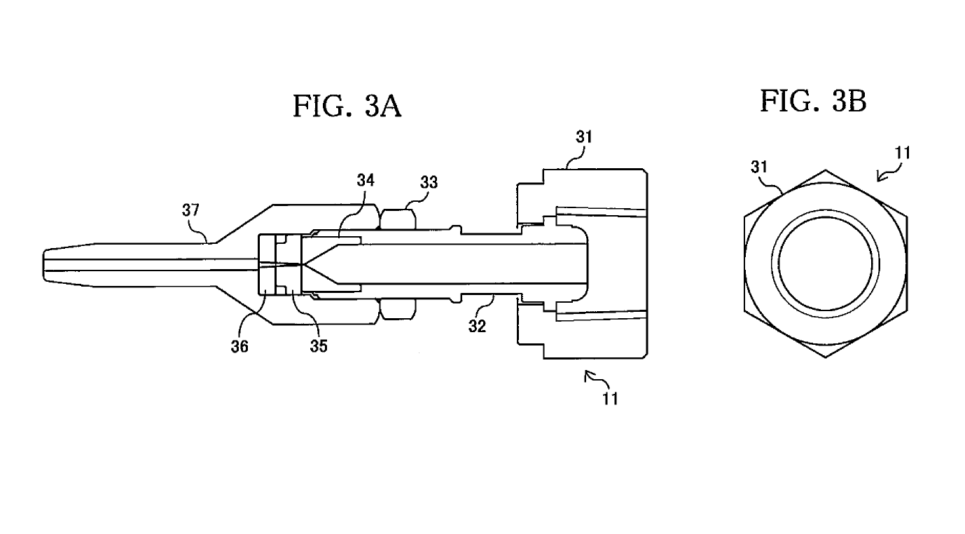

As illustrated in FIGS. 3(A) and 3(B), the nozzle 11 includes a nozzle body 37, a first gasket 36, a second gasket 35, a plunger 34, a first nut 33, a gland 32, and a second nut 31. Specifically, the first gasket 36, the second gasket 35, and the plunger 34 are connected, in this order, to a base end side of the nozzle body 37, and the tip end of the gland 32 is connected to the plunger 34. The first gasket 36, the second gasket 35, the plunger 34, and the gland 32 are fixed to the nozzle body 37 by using the first nut 33. The second nut 31 is attached to a base end of the gland 32. A path for allowing liquefied CO₂ 13 to pass through is provided inside the nozzle 11 having the structure described above.

A hard film having a Vickers hardness of Hv 1000 to 5000 is formed on an inner wall (surface constituting a path for allowing liquefied CO₂ 13 to pass through) of the nozzle 11. Preferably, this hard film is a film containing one selected from the group consisting of diamond like carbon (DLC), TiN, TiCrN, CrN, TiCNi, TiAlN, Al₂O₃, AlCrN, ZrO₂, SiC, Cr, NiP, WC, SiO₂, Ta₂O₅, SiN, and SiaAlbOcNd (sialon). However, in the embodiment, a DLC film containing not more than 30 atomic % of hydrogen is used as the hard film. The DLC film can be made harder by containing not more than 30 atomic % of hydrogen. Furthermore, it is preferable that the DLC film has a Vickers hardness of Hv 1200 to 3500.

The DLC film described above is formed on the inner wall of the nozzle 11 by a plasma CVD method using a high-frequency output with a frequency of 10 kHz to 1 MHz (preferably 50 kHz to 800 kHz, more preferably 50 kHz to 500 kHz). It is possible to form the hard DLC film by using a frequency of 10 kHz to 1 MHz as described above.

As illustrated in FIG. 1, the nozzle 11, the substrate 12, the holding mechanism, and the exhaust path 22 are disposed within the chamber 27. Furthermore, the cleaning device has an introduction mechanism for introducing dry air 44 or nitrogen gas into the chamber 27, and a relief valve 43 is disposed in the chamber 27. When cleaning the substrate 12, the introduction mechanism introduces the dry air 44 or nitrogen gas into the chamber 27, and the dry air or nitrogen gas is ejected to the outside of the chamber 27 by using the relief valve 43, with the result that the dew point is controlled to be approximately −20° C. under an atmosphere of the dry air or nitrogen (−70° C. to −100° C.). The reason for employing such an atmosphere is that CO₂ particles used for cleaning the substrate 12 have a temperature of approximately −73° C., and thus the substrate 12 is cooled when the CO₂ particles are sprayed onto the substrate 12, and water droplets are more likely to be attached onto the substrate 12, thereby being prevented from being attached onto the substrate 12. Moreover, it is possible to prevent water droplets from being attached onto the substrate 12 by heating the substrate 12 through the use of the heater 19 at the time of cleaning the substrate 12.

Next, description will be made of a method of cleaning a substrate by using the cleaning device illustrated in FIG. 1.

First, the substrate 12 is placed on the holding portion 17, and the substrate 12 is vacuum-sucked to the holding portion 17 and held, by evacuation with the vacuum pump 18. The position of the substrate 12 is regulated so that the angle θ₁ formed by the horizontal plane and the surface on the side opposite to the front surface (surface to be cleaned) of the substrate 12 is within a range of 45° to 180° (preferably 70° to 110°). Note that, in FIG. 1, the θ₁ is 90°.

Then, the inside of the chamber 27 is controlled so as to have the dew point of approximately −20° C. under an atmosphere of the dry air or nitrogen (−70° C. to −100° C.), by introduction of the dry air 44 or nitrogen gas into the chamber 27.

Subsequently, the pressurized liquefied CO₂ 13 within the cylinder 14 is supplied to the nozzle 11 through the piping 15 and the valve 16, by opening the valve 16. In addition, the liquefied CO₂ 13 flowing into the gland 32 is compressed inside the plunger 34 having a smaller cross-sectional area as flowing toward the tip end side, and is accelerated by the Venturi effect with which the fluid velocity increases at an orifice (the narrowest portion) of the tip end of the plunger 34. The accelerated liquefied CO₂ 13 adiabatically expands by the first and second gaskets 36 and 35 having a cross-sectional area widened toward the end to thereby give CO₂ particles, and the CO₂ particles thus obtained is rectified by the nozzle body 37. The CO₂ particles having rectified are ejected from the nozzle body 37 in a direction 21 diagonal with respect to the front surface 12b of the substrate 12. These ejected CO₂ particles are sprayed onto the front surface 12b of the substrate 12 as indicated by the arrow 26 illustrated in FIG. 2 while the front surface is scanned, and thus the entire front surface of the substrate 12 is cleaned. At this time, particles or the like on the front surface of the substrate 12 are blown off by the CO₂ particles sprayed onto the front surface of the substrate 12, and the particles or the like blown off pass through the exhaust port 22a, the exhaust path 22, the pressure control valve 41, and the HEPA filter 42 while making use of the gravity as indicated by the arrow 24, and are exhausted to the outside of the chamber 27 by the exhaust means 23.

After that, the substrate 12 held by the holding portion 17 by 45° or 90° is rotated through rotation of the holding portion 17 by 45° or 90° as indicated by the arrow 25.

Then, in the same way as that described above, the CO₂ particles are sprayed onto the front surface 12b of the substrate 12 while the front surface 12b is scanned to thereby clean the entire surface of the surface 12. At this time, particles or the like, blown off, on the surface of the substrate 12 pass through the exhaust port 22a, the exhaust path 22, the pressure control valve 41, and the HEPA filter 42 as indicated by the arrow 24, and are exhausted by using the exhaust means 23.

After that, cleaning the surface of the substrate 12 is completed, by repletion of rotating the substrate 12 held by the holding portion 17 by 45° or 90° in the same way as that described above, and of cleaning the entire surface of substrate 12 in same way as that described above.

According to the embodiment, a hard film having a Vickers hardness of Hv 1000 to 5000 is formed on the inner wall of the nozzle 11, and thus, even if CO₂ particles collide with the inner wall of the path of the nozzle 11 when the liquefied CO₂ passes through the nozzle 11, it is possible to suppress erosion of the inner wall of the path. Therefore, it is possible to suppress the contamination, due to metal, of the surface of the substrate 12 after cleaning, even if CO₂ particles are used to clean the substrate 12. Furthermore, it is possible to prolong lifetime of the nozzle 11.

Moreover, according to the embodiment, the position of the substrate 12 when CO₂ particles ejected from the nozzle are sprayed onto the substrate 12 is set at the angle θ₁ in the range of 45° to 180°, the angle θ₁ formed by the horizontal plane and the surface on the side opposite to the front surface (surface to be cleaned) of the substrate 12, and then particles or the like, blown off, on the surface of the substrate 12 are exhausted, while making use of the gravity, from a lower part of the substrate 12 as indicated by the arrow 24. Therefore, it is possible to suppress re-attachment of the particles or the like onto the substrate 12.

Namely, the substrate 12 is disposed at a position where the angle θ₁ is within the range of 45° to 180°, and the exhaust path 22 and the exhaust means 23 are disposed at a lower part of the substrate 12, and thus it is possible to exhaust particles or the like by utilizing not only exhaust power obtained by the exhaust means 23 but also the force of the gravity, at the time of exhausting the particles or the like. As a result, after particles or the like on the substrate 12 are blown off by CO₂ particles, it is possible to suppress re-attachment of the particles or the like onto the surface of the substrate 12. Therefore, it is possible to suppress decrease in the cleaning effect due to re-attachment of the particles or the like.

Furthermore, according to the embodiment, the exhaust path 22 of the exhaust mechanism has a path extending at a lower part of the exhaust port 22a, and thus, at the time of discharging particles or the like, it is possible to suppress re-attachment of the particles or the like onto the surface of the substrate 12.

Moreover, according to the embodiment, when CO₂ particle ejected from the nozzle are sprayed onto the substrate 12 to thereby clean the substrate 12, the particles or the like blown off from the substrate 12 pass through the exhaust port 22a, the exhaust path 22, the pressure control valve 41, and the HEPA filter 42, and are exhausted to the outside of the chamber 27, by using the exhaust means 23. Therefore, unlike the conventional technique, it is possible to suppress re-attachment of small particles or the like the HEPA filter cannot capture, onto the substrate. As a result, the decrease in the cleaning effect of surface of the substrate can be suppressed.

Brief Description of the Reference Symbols
11 nozzle
12 substrate
12a surface (back surface) on the side opposite to a surface to be cleaned (front surface) of the substrate
12b surface to be cleaned (front surface) of substrate
13 liquefied carbon dioxide (liquefied CO₂)
14 cylinder
15 piping
16 valve
17 holding portion
18 vacuum pump
19 heater
20 horizontal plane
21 direction of CO₂ particles ejected from nozzle
22 exhaust path
22a exhaust port
23 exhaust means
24, 25, 26 arrow
27 chamber
31 second nut
32 gland
33 first nut
34 plunger
35 second gasket
36 first gasket
37 nozzle body
41 pressure control valve
42 HEPA filter
43 relief valve
44 dry air
101 nozzle
102 substrate
103 CO₂ particle
104 duct
104a suction port

1. A nozzle that causes CO₂ particles to be ejected to a substrate, wherein
a hard film having a Vickers hardness of Hv 1000 to 5000 is formed on an inner wall of said nozzle.

2. The nozzle according to claim 1, wherein
said hard film is a film containing one selected from the group consisting of DLC, TiN, TiCrN, CrN, TiCNi, TiAlN, Al₂O₃, AlCrN, ZrO₂, SiC, Cr, NiP, WC, SiO₂, Ta₂O₅, SiN, and SiaAlbOcNd (sialon).

3. The nozzle according to claim 1, wherein
said hard film is a DLC film, and
said DLC film contains not more than 30 atomic % of hydrogen.

4. The nozzle according to claim 3, wherein
said DLC film is formed by a plasma CVD method using a high-frequency output with a frequency of 10 kHz to 1 MHz.

5. The nozzle according to claim 3, wherein
said DLC film is formed by a plasma CVD method using a high-frequency output with a frequency of 50 kHz to 500 kHz.

6. The nozzle according to claim 1, wherein
said nozzle is a Venturi tube.

7. A cleaning device, comprising:
the nozzle according to claim 1;
a CO₂ supplying mechanism that supplies pressurized CO₂ to said nozzle; and
a holding mechanism that holds a substrate, wherein
the pressurized CO₂ is supplied to said nozzle, and CO₂ particles ejected from said nozzle are used to clean said substrate held by said holding mechanism.

8. The cleaning device according to claim 7, comprising:
an exhaust mechanism disposed at a lower part of said substrate held by said holding mechanism, wherein
said holding mechanism holds said substrate at a position where an angle formed by a horizontal plane and a surface on a side opposite to a surface to be cleaned of said substrate is in a range of 45° to 180°.

9. The cleaning device according to claim 8, wherein
an angle formed by a direction in which CO₂ particles are ejected from said nozzle and a surface to be cleaned of said substrate is in a range of 20° to 90°.

10. The cleaning device according to claim 8, wherein
said exhaust mechanism includes an exhaust port disposed at a lower part of said substrate, and an exhaust path connected to said exhaust port, and
said exhaust path has a path extending at a lower part of said exhaust port.

11. The cleaning device according to claim 8, wherein
said substrate held by said holding mechanism and said nozzle are disposed within a chamber, and
a gas exhausted by said exhaust mechanism is discharged to an outside of said chamber.

12. A cleaning device, comprising:
a holding mechanism that holds a substrate;
a nozzle that causes CO₂ particles to be ejected to said substrate held by said holding mechanism;
a CO₂ supplying mechanism that supplies pressurized CO₂ to said nozzle; and
an exhaust mechanism disposed at a lower part of said substrate held by said holding mechanism, wherein
said holding mechanism holds said substrate at a position where an angle formed by a horizontal plane and a surface on a side opposite to a surface to be cleaned of said substrate is in a range of 45° to 180°.

13. The cleaning device according to claim 12, wherein
said exhaust mechanism includes an exhaust port disposed at a lower part of said substrate, and an exhaust path connected to said exhaust port, and
said exhaust path has a path extending at a lower part of said exhaust port.

14. The cleaning device according to claim 12, wherein
said substrate held by said holding mechanism and said nozzle are disposed within a chamber, and
a gas exhausted by said exhaust mechanism is discharged to an outside of said chamber.

15. A cleaning device, comprising:
a holding mechanism that holds a substrate;
a nozzle that causes CO₂ particles to be ejected to said substrate held by said holding mechanism;
a CO₂ supplying mechanism that supplies pressurized CO₂ to said nozzle; and
an exhaust mechanism disposed at a lower part of said substrate held by said holding mechanism, wherein
said exhaust mechanism includes an exhaust port disposed at a lower part of said substrate, and an exhaust path connected to said exhaust port, and
said exhaust path has a path extending at a lower part of said exhaust port.

16. The cleaning device according to claim 15, wherein
said substrate held by said holding mechanism and said nozzle are disposed within a chamber, and
a gas exhausted by said exhaust mechanism is discharged to an outside of said chamber.

17. A cleaning method of a substrate by using CO₂ particles ejected from a nozzle, wherein
a hard film having a Vickers hardness of Hv 1000 to 5000 is formed on an inner wall of said nozzle.

18. The cleaning method according to claim 17, wherein
said hard film is a film containing one selected from the group consisting of DLC, TiN, TiCrN, CrN, TiCNi, TiAlN, Al₂O₃, AlCrN, ZrO₂, SiC, Cr, NiP, WC, SiO₂, Ta₂O₅, SiN, and SiaAlbOcNdq (sialon).

19. The cleaning method according to claim 17, wherein
said hard film is a DLC film, and
said DLC film contains not more than 30 atomic % of hydrogen.

20. The cleaning method according to claim 17, wherein,
when said substrate is cleaned, said substrate is disposed at a position where an angle formed by a horizontal plane and a surface on a side opposite to a surface to be cleaned of said substrate is in a range of 45° to 180°.

21. A cleaning method of a substrate by using CO₂ particles ejected from a nozzle, wherein,
when said substrate is cleaned, said substrate is disposed at a position where an angle formed by a horizontal plane and a surface on a side opposite to a surface to be cleaned of said substrate is within a range of 45° to 180°.

22. The cleaning method according to claim 20, wherein
exhaustion is performed from a lower part of said substrate when said substrate is cleaned.

23. A cleaning method of a substrate by using CO₂ particles ejected from a nozzle, wherein
exhaustion is performed through an exhaust path and an exhaust port disposed at a lower part of said substrate when said substrate is cleaned, and
said exhaust path is connected to said exhaust port, and is a path extending at a lower part of said exhaust port.

24. The cleaning method according to claim 23, wherein
said substrate and said nozzle are disposed within a chamber, and
a gas exhausted by said exhaust path is discharged to an outside of said chamber.
